(19) United States
(12) Patent Application Publication
(10) Pub. No.: US 2012/0084819 A1
(43) Pub. Date: Apr. 5, 2012

(54) SYSTEM AND METHOD FOR PROVIDING SERVICE SEARCH

(75) Inventor: Bong-Jin OH, Daejeon (KR)

(73) Assignee: Electronics and Telecommunications Research Institute, Daejeon-city (KR)

(21) Appl. No.: 13/227,238

(22) Filed: Sep. 7, 2011

(30) Foreign Application Priority Data
Oct. 4, 2010 (KR) 10-2010-0096496

(51) Int. Cl. H04N 21/431

(52) U.S. Cl. 725/53

(57) ABSTRACT

Disclosed herein is a method and system for providing service search. The system for providing service search includes an index formation unit, a container configuration unit, a guide configuration unit, and a transmission and reception unit. The index formation unit forms an index structure including an index list area, an index area, and a sub-index area. The container configuration unit configures an integrated container by integrating service information, schedules, and program information for each of service identifiers (IDs) included in the sub-index area. The guide configuration unit configures an Electronic Program Guide (EPG) including the index structure. The transmission and reception unit provides the EPG using a service ID corresponding to information desired by the terminal, together with the index structure.

### CROSS REFERENCE TO RELATED APPLICATION

This application claims priority to Korean Patent Application No. 10-2010-0096496, filed on Oct. 4, 2010, the entire contents of which is herein incorporated by reference.

### BACKGROUND OF THE INVENTION

1. Technical Field

The present invention relates to a method and system for providing service search.

2. Description of the Related Art

As the analog environment has changed to a digital one, the broadcasting service has evolved into a form in which various content support services and data services, offered in the existing communication field, have converged into a single service and the converged service is provided to users.

Recent smart televisions (hereinafter referred to as “TVs”) profess themselves to be devices that allow not only services provided by service providers but also content and services provided over the open Internet to be freely searched for and executed. Accordingly, in order to enable various types of content and service to be searched, Internet Protocol TV (IPTV), Internet TV and smart TV service providers are tending to replace existing broadcast-oriented service search technology with web search or extensible markup language (hereinafter referred to as “XML”)-type technology. In particular, TV-Anytime (hereinafter referred to as “TVA”) is being utilized as a reference standard domestically and abroad, and reference is being made to it to establish standards in fields, such as the domestic IPTV and Digital Multimedia Broadcasting (DMB) fields.

In TVA, information necessary to perform XML-based service search (hereinafter referred to as “service search information”) is described and a document structure and tables therefor are defined. Accordingly, it can be seen that definitions sufficient to describe various types of service and content, such as broadcasts, Video on Demand (hereinafter referred to as “VoD”) and applications, were already included in TVA.

XML-based service search information has the disadvantages of the sizes of documents being relatively large and the amount of information related to search service being large because the service search information is described in text form. Although this has been taken into account by conventional service information for broadcast channels, it is being further taken into account as support for VoD or content is added.

In order to overcome these disadvantages, TVA defines the encapsulation of XML documents using encoding and indexing.

Encapsulation is configured to separate an XML document in nonlinear tree form into independent entities, reduce the sizes of the separate entities using a compression algorithm, include the encoded document in a block called a container, and describe configuration information in a container header.

During encapsulation, information that enables a terminal to be notified of the container where each XML document is located and the sequential position at which the XML document is located in the container (hereinafter referred to as an “index”) is created.

The terminal receives indexes, analyzes necessary indexes to configure service guide information, receives data containers in which XML documents are carried, extracts necessary information, and stores it in a cache in the terminal. Such information is used to perform output to a user in processed form using an application such as an Electronic Programming Guide (hereinafter referred to as an “EPG”).

The conventional TVA index structure has the problem of providing a definition so that a single index is used to search for a single XML document type. That is, in order to configure an EPG for real-time broadcasting service, service information, program information, and schedule fragment information are required. Here, the schedule fragment information is information that enables independent separation from an XML document.

Accordingly, when the conventional index structure is employed, at least three indexes should be configured and location information should be described in sub-indexes. In this case, the terminal collects documents of the three types using the location information described in the sub-indexes, extracts information, and connects and manages related information.

However, the terminal suffers from the problems of an increase in the number of indexes to be managed and overhead in the analysis of data container to be received. That is, the terminal can finally determine the range of received information by storing all sub-indexes, searching these sub-indexes, and checking the number of pieces of information contained in each data container.

In general, since the capacity of the storage device, such as memory, or performance of a terminal for providing broadcasting service is limited so as to reduce the cost of the terminal, such an index structure creates a burden. Furthermore, in the case of a real-time broadcast channel, users expect that information is displayed on a screen at the moment the corresponding button of an EPG is pressed, unlike in the case of content on demand such as VoD, a search procedure and the range of information should be simplified such that information can be acquired in a terminal booting procedure as fast as possible.

Accordingly, there is a need for a new method of providing service search that is capable of configuring, sending and receiving indexes and data containers so that pieces of necessary information can be searched for and received at the same time.

### SUMMARY OF THE INVENTION

Accordingly, the present invention has been made keeping in mind the above problems occurring in the prior art, and an object of the present invention is to provide a method and system for providing service search, by which a service provider can efficiently configure and send service and content search information.

Another object of the present invention is to provide a method and system for providing service search, which gives support so that a terminal can search for necessary information fast using improved indexes.

In order to accomplish the above objects, the present invention provides a system for providing service search, including an index formation unit for forming an index structure including an index list area, an index area, and a sub-index area; a container configuration unit for configuring an integrated container by integrating service information, schedules, and program information for each of service identifiers (IDs) included in the sub-index area; a guide configuration unit for configuring an Electronic Program Guide (EPG) including the index structure; and a transmission and reception unit for providing the EPG using a service ID corresponding to information desired by the terminal, together with the index structure.

Additionally, in order to accomplish the above objects, the present invention provides a method in which a service search provision system provides service search, including forming an index structure including an index list area, an index area, and a sub-index area; configuring an integrated container by integrating service information, schedules, and program information for each of service IDs included in the sub-index area; configuring an EPG including the index structure; and providing the EPG using a service ID corresponding to information desired by the terminal, together with the index structure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the index structure of TVA;

FIG. 2 is a diagram showing the configuration of the system for providing service search according to the embodiment of the present invention;

FIG. 3 is a diagram illustrating an index structure according to an embodiment of the present invention;

FIG. 4 is a diagram illustrating values added to the fragment type field in the index structure according to an embodiment of the present invention;

FIG. 5 is a diagram illustrating an index structure using a service ID and a start time according to an embodiment of the present invention;

FIG. 6 is a diagram illustrating a fragment locator format to which a container locator has been assigned, according to an embodiment of the present invention;

FIG. 7 is a diagram illustrating fragment location information according to an embodiment of the present invention;

FIG. 8 is a flowchart illustrating a method of providing service search according to an embodiment of the present invention;

FIG. 9 is a diagram illustrating a real-time broadcasting service to which the method of providing service search according to an embodiment of the present invention has been applied;

FIG. 10 is a diagram illustrating a container structure according to an embodiment of the present invention; and

FIG. 11 is a diagram illustrating an index container structure that enables fragment locators to be searched for, according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings. Here, redundant descriptions and descriptions of well-known functions and elements that may unnecessarily make the gist of the present invention vague will be omitted. Embodiments of the present invention are provided to more fully describe the present invention to those having ordinary knowledge in the art to which the present invention pertains. Accordingly, the shapes and sizes of elements in the drawings may be exaggerated to provide clearer descriptions.

A method and system for providing service search according to an embodiment of the present invention will be described in detail below with reference to the accompanying drawings.

First, encapsulation divides an XML document in nonlinear tree form into independent entities, and then reduces the sizes of the separate entities by encoding them using a compression algorithm. Thereafter, encapsulation includes the encoded document in a block called a container, and describes configuration information in a container header.

In such an encapsulation process, information notifying a terminal of the container where an XML document is located and the sequential position at which the XML document is located in the container (hereinafter referred to as an “index”).

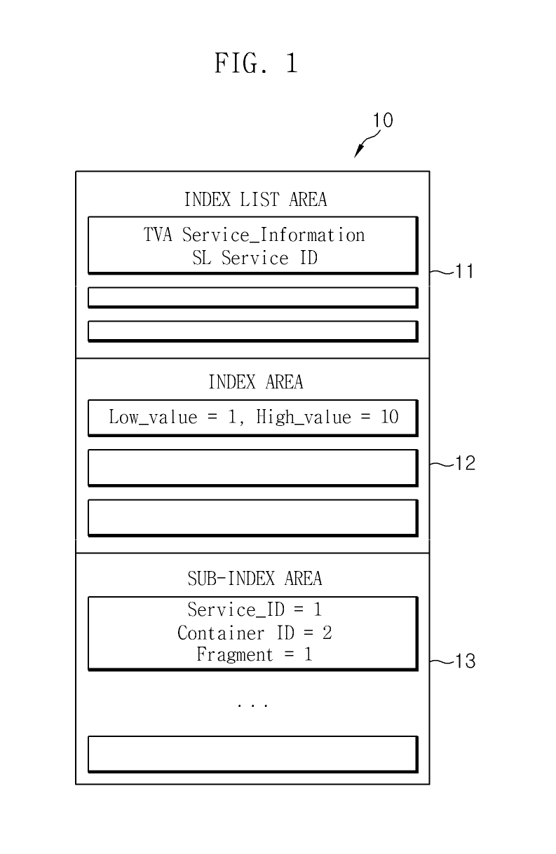

FIG. 1 is a block diagram illustrating the index structure of TVA.

Referring to FIG. 1, a TVA index includes a container 10, and the container 10 includes an index list area 11, an index area 12, and a sub-index area 13.

The index list area 11 is an area where a combination of a document type (fragment type) and a field, which is used as a key for searching, is stored.

The index area 12 is an area where the search range or value range of each field is stored. In the index area 12, for example, the search range or value range may be set to values between the minimum value Low_Value and the minimum value High_Value and then be stored.

The sub-index area 13 is an area where the location information list of XML documents included in the range of each field is stored. Here, the location information list includes service IDs, container IDs, and fragment IDs.

In the method and system for providing service search according to the embodiments of the present invention, an index is extensively defined based on the TVA index structure so as to enable a plurality of XML document fragment types to be searched for at one time. For this purpose, a service provider allows fragments, including a plurality of XML document types configured under a single condition, to be configured in a single data container.

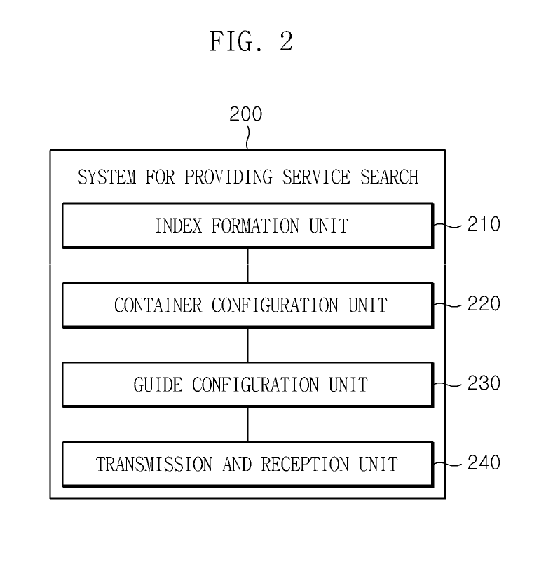

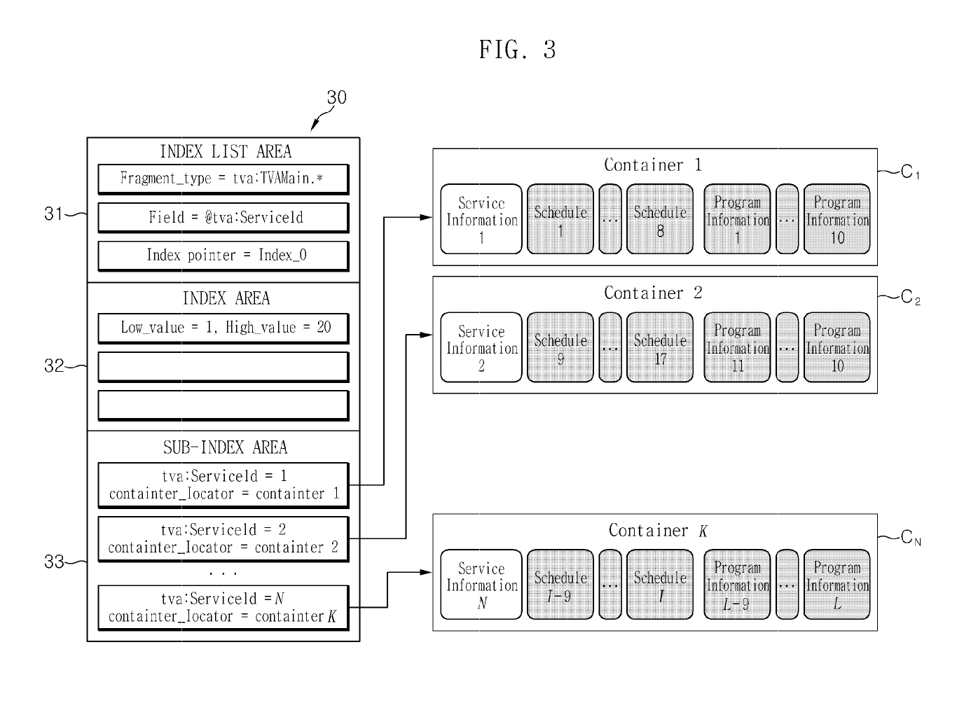

Next, the system for providing service search using an index, which enables a plurality of types of XML documents to be searched for, will now be described in detail below with reference to FIGS. 2 to 3.

FIG. 2 is a diagram showing the configuration of the system for providing service search according to the embodiment of the present invention. Furthermore, FIG. 3 is a diagram illustrating an index structure according to an embodiment of the present invention.

Referring to FIG. 2, the system 200 for providing service search includes an index formation unit 210, a container configuration unit 220, a guide configuration unit 230, and a transmission and reception unit 240.

The index formation unit 210 forms an index having an index structure 30, such as that of FIG. 3.

Referring to FIG. 3, the index structure 30 according to the embodiment of the present invention includes an index list area 31, an index area 32, and a sub-index area 33.

The index list area 31 includes a fragment type, a field, and an index pointer.

The index area 32 includes a service search range or a value range, for example, the minimum value Low_Value and the maximum value High_Value.

The sub-index area 33 includes service IDs corresponding to the location information list of XML documents included in the range of each field.

The container configuration unit 220 integrates service information, schedules and program information into a single container under a specific condition. Here, the container configuration unit 220 includes a day's schedules and program information included in each service ID, that is, Electronic Program Guide (EPG) information, in a single container using the service ID of service information as a search condition. That is, a single data container is configured for each service ID. For example, a first container C1 is configured when the service ID is “1,” a second container C2 is configured when the service ID is “2,” and an N-th container CN is configured when the service ID is “N.”

The guide configuration unit 230 configures and stores an EPG including the index structure 30.

The transmission and reception unit 240 provides the configured container to a terminal, and transfers information to the terminal in the form of information which has been processed using an EPG corresponding to information desired by the user of the terminal.

Then, the terminal can obtain necessary fragments by receiving the container. Furthermore, the terminal can determine the number of necessary containers by storing and searching for only a number of sub-index areas 23 equal to the number of channels, which belong to the processed information.

As described above, the index structure 30 corresponding to the method of providing service search according to an embodiment of the present invention guarantees that fragments included in each container are information necessary to describe a single channel, and can reduce the procedure of analyzing and receiving necessary information, compared to a conventional method of providing service search.

Next, a method of configuring an index supporting a plurality of fragment types in the system 200 for providing service search will be described.

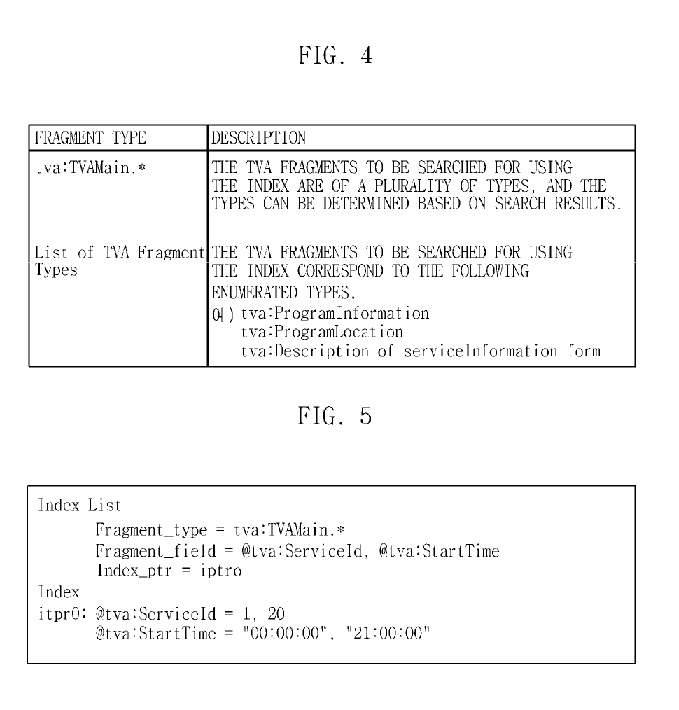

First, in the plurality of areas 31, 32 and 33 included in the index structure, a plurality of pieces of information defined for indexing is extended. For example, values added to the fragment type field of the index list area 31 are shown in FIG. 4.

FIG. 4 is a diagram illustrating values added to a fragment type field in an index structure according to an embodiment of the present invention.

Referring to FIG. 4, the system 200 for providing service search defines a fragment type to be searched for in the index structure, thereby enabling a plurality of fragment types to be searched for, and also extends a field necessary to search for the plurality of fragment types.

The system 200 for providing service search indicates that an index in question is an index for searching for a plurality of fragment types using, for example, “tva:TVAMain.*”or a similar type of text. Here, the plurality of fragment types includes program information, program locations, and service information.

The system 200 for providing service search notifies the terminal of the fragment types, thereby providing notification of the plurality of fragment types in a container to be searched for.

That is, the system 200 for providing service search sequentially describes service information, schedules and program information in XML Path Language (Xpath), thereby notifying the terminal of the fact that three fragment types for an EPG are present in a container to be searched for.

Although in FIG. 4, the fragment types are defined in Xpath, it may be defined by mapping each fragment to an ID.

That is, the system 200 for providing service search extensively uses a plurality of pieces of information defined for conventional indexing by assigning IDs to fragments previously standardized in TVA specifications, for example, in such a way as to map “tva:TVAMain.*” to ID 1 and map “tva:ServiceInformation” to ID 2.

The field corresponds to a search field, and is defined as a certain field included in a fragment to be searched or a combination of fields. Here, the field uses the service ID of service information and the start time of a schedule.

The system 200 for providing service search according to the embodiment of the present invention may employ not only the method of providing a day's EPG information to a terminal using a service ID but also a method of including specific time-based information for each channel in a container using a service ID and a start time and sending it. An index structure using a service ID and a start time is illustrated in FIG. 5.

Referring to FIG. 5, the system 200 for providing service search divides a day's EPG information into pieces of three hours-based information for each of channels 1 to 20, and then send it. That is, when the terminal receives a single container, it determines that a schedule and program information for a specific channel and specific three hours are contained in the container. Here, it is assumed that the terminal and a corresponding service provider have fully understood the procedure necessary to construct EPG information.

The procedure of constructing EPG information requires three types of fragments, and the relationship therebetween can be determined using a service ID and CRIDs.

The service information includes detailed information about a channel, and includes a service ID. The schedule includes schedule information for each channel and program locations, and each of the program locations includes a service ID and a CRID.

That is, the system 200 for providing service search may associate the service information with the schedule using the service ID, and may associate the schedule with the program information using the CRID.

From the standpoint of the terminal, it has been previously known that three fragment types for an EPG should be transferred and it should be determined how documents are configured and transferred using the index.

Accordingly, there is a need for a system 200 for providing service search that configures an index that can minimize the resources of the terminal and simplify a search procedure.

The conventional system for providing service search enumerates all fragments, corresponding to the range of a field specified in the index area, in the sub-index area, and allows the terminal to sequentially search services.

However, the system for providing service search according to the embodiment of the present invention extends the method of representing a fragment locator format, thereby enabling a plurality of XML document types to be searched for and also minimizing a search procedure.

Referring to FIG. 3, the system 200 for providing service search defines a container locator by extending the fragment locator format defined in the TVA standard, as described above. That is, as the system 200 for providing service search defines location information for each container, all fragments included in a container are not included in a sub-index, and a fragment set can be represented at one time.

In the index standard of the TVA standard, according to the fragment locator format, whether the type of location information is present in a local container or a remote container is determined. If the type of location information is present in a remote container, the location information is determined using a container ID and a fragment ID in the container.

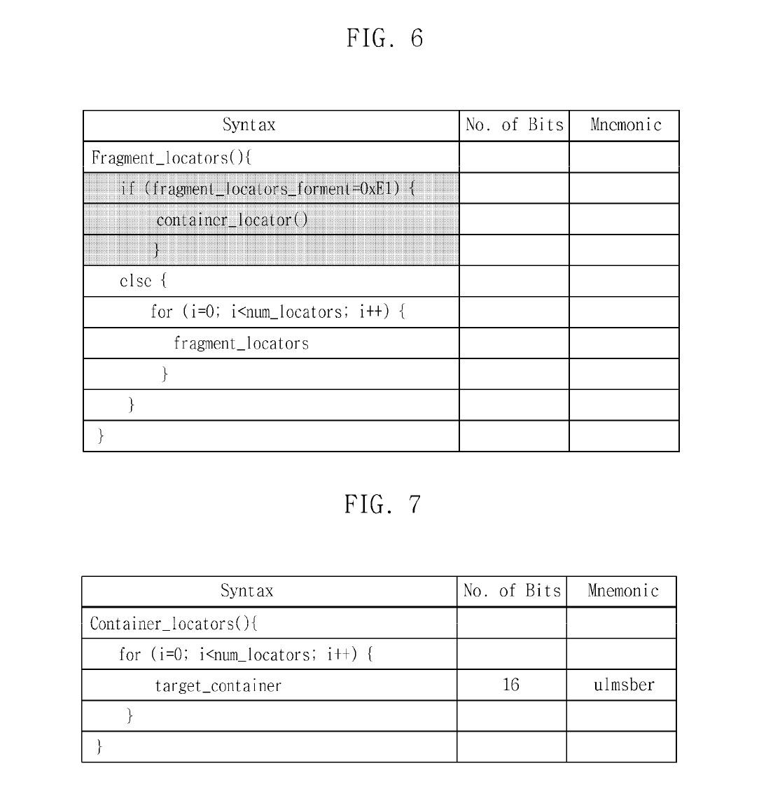

A fragment locator format according to an embodiment of the present invention is configured in such a way that a container locator is assigned to 0xE1 and addition is made as shown in FIG. 6. Furthermore, a container locator is extended in the fragment locator format of the TVA standard, and then the structure of FIG. 6 is used as fragment location information when the fragment locator format corresponds to 0xE1.

From FIG. 7, it can be seen that in a container locator structure, fragments that meet the condition of a specific key are included in the list of a container specified as a target container. Furthermore, the system for providing service search may divide fragments, and include them in a plurality of containers if a single container is insufficient because the number of fragments that meet the condition of a specific key is excessively large.

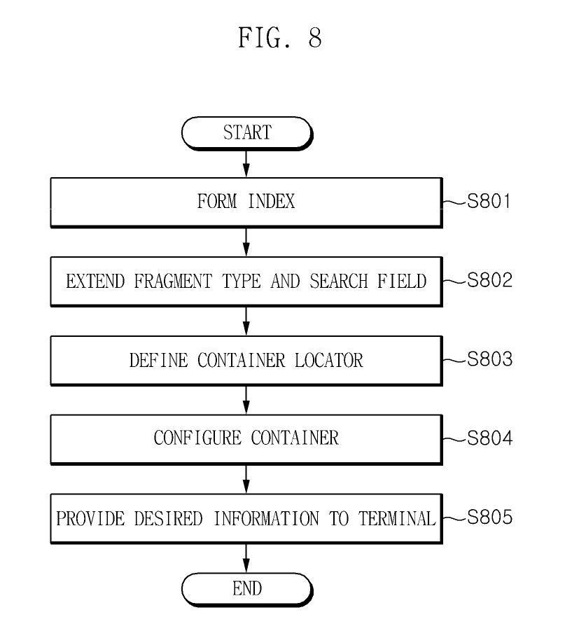

FIG. 8 is a flowchart illustrating a method of providing service search according to an embodiment of the present invention.

Referring to FIG. 8, the system 200 for providing service search forms an index including an index list area 31, an index area 32, and a sub-index area 33 at step S801.

Here, the index list area 31 includes a fragment type, a field, an index pointer, and the index area 32 includes a service search range or a value range. Furthermore, the sub-index area 33 includes service IDs corresponding to the location information list of XML documents included in the range of each field.

The system 200 for providing service search extends the fragment type and the search field in the configured index at step S802. Here, the fragment type includes program information, program locations, and service information.

In detail, the system 200 for providing service search extends the fragment type and the search field in the index list area 31 included in the index, thereby enabling a plurality of fragment types to be searched for and also extending the definition of the field necessary to perform the search. Here, the field uses the service ID of service information and the start time of a schedule.

Although the system 200 for providing service search according to the embodiment of the present invention defines a fragment type in Xpath, the fragment type may be defined by mapping a fragment to an ID.

Thereafter, the system 200 for providing service search defines a container locator by extending a fragment locator format at step S803. That is, the system 200 for providing service search defines a locator for each container, and can represent fragments, included in the container, as a single set.

The system 200 for providing service search integrates service information, schedules and program information in a single container corresponding to the defined container locator under a specific condition at step S804. Here, the system 200 for providing service search includes a day's schedules and program information included in each service ID, that is, an EPG, in a single container using the service ID of service information as a search condition.

The system 200 for providing service search provides the configured container to a terminal, and transfers information to the terminal in the form of information which has been processed using an EPG corresponding to information desired by the user of the terminal.

Providing the EPG together with the container corresponding to the index structure means providing the index structure and the program guide from the system to the terminal, but does not mean transmitting the index structure and the EPG at the same time. For example, the terminal may have the index structure before the EPG is sent.

The steps described in conjunction with FIG. 8 may be performed in the sequence illustrated in FIG. 8, in the reverse sequence, or at the same time.

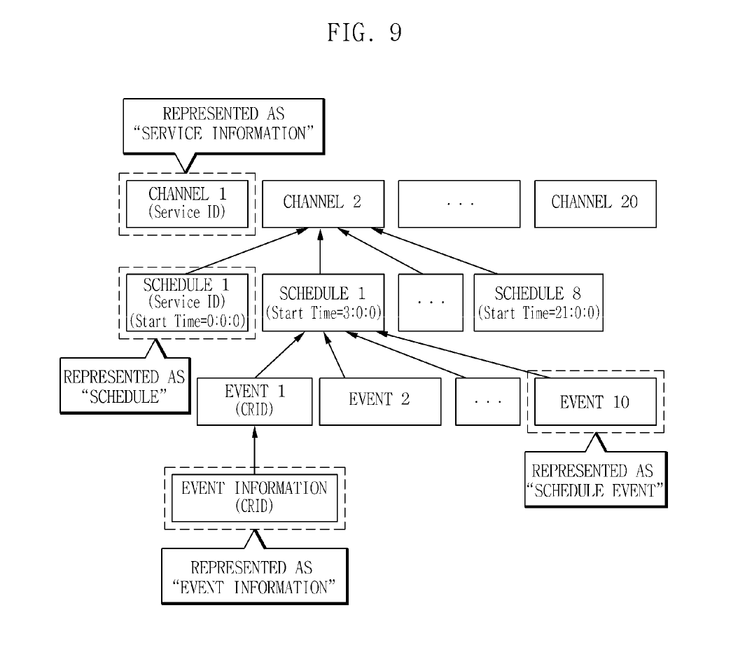

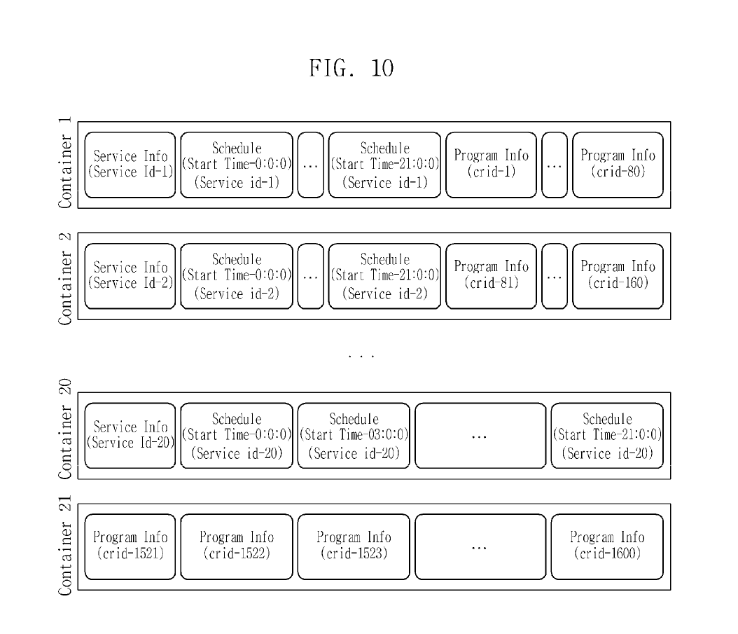

Next, a real-time broadcasting service to which the method of providing service search has been applied will be described in detail with reference to FIG. 9.

FIG. 9 is a diagram illustrating a real-time broadcasting service to which the method of providing service search according to an embodiment of the present invention has been applied.

Referring to FIG. 9, it is assumed that in a real-time broadcasting service, a total of 20 channels channel 1˜channel 20 corresponding to a service ID are configured and 8 pieces of schedule information schedule 1˜schedule 8 for every three hours of 24 hours are configured for each of the channels. Here, the schedule information includes a schedule ID and the start time of a corresponding schedule.

Furthermore, it is assumed that a single piece of schedule information include events CRIDs, for example, broadcast programs. For example, it is assumed that a three hour-based schedule includes 10 events, for example, 10 broadcast programs, to be broadcast at scheduled times and detailed information about each event is sent via separate fragment information.

Next, a data container structure including fragments corresponding to the information of a real-time broadcasting service will be described in detail with reference to FIG. 10.

FIG. 10 is a diagram illustrating a container structure according to an embodiment of the present invention.

Referring to FIG. 10, each of a plurality of containers Container1˜Container21 includes a piece of service information about a channel corresponding to a service ID, eight schedules each including three hour-based schedule information, and 80 pieces of program information including descriptions of events included in the schedules. Here, in the case of the last channel, fragments are divided and stored and then sent in two containers Container20 and Container21. That is, fragments that meet a specific condition may be configured in a plurality of containers, but the present invention is not limited thereto.

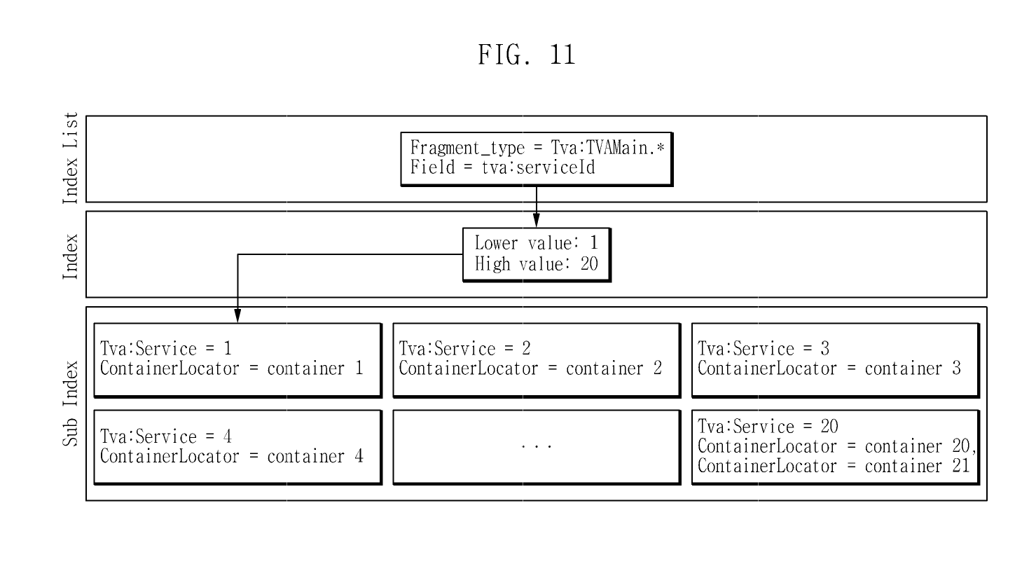

Next, an index container structure that enables the locations of necessary fragments to be easily searched for will be described in detail with reference to FIG. 11.

FIG. 11 is a diagram illustrating an index container structure that enables fragment locators to be searched for, according to an embodiment of the present invention.

Referring to FIG. 11, the fragment type in the index list area 31 is specified as “tva:TVAMain.*,” thereby indicating that a plurality of TVA fragment types will be searched for. Furthermore, the field in the index list area 31 specifies that fragments corresponding to each channel will be filtered using “@tva:ServiceId.”

Next, in the index area 32, the search range or value range of the field is specified as channels 1 to 20. In the sub-index area 33, container locators are sequentially described for the respective channels. Since the last container locator includes the containers 20 and 21 that contain information for the channel 20, it indicates that two containers should be received.

When the conventional TVA index structure is employed, three indexes are required because indexes for searching for three types of fragments should be defined and the range of field values for each index should be specified. Furthermore, since fragment locators for three types of fragments are enumerated in the sub-index, there arise the problems of the terminal assigning memory for storing sub-indexes (for 20 pieces of service information, 160 schedules, and 1600 pieces of program information) and all fragment locators having to be searched so as to analyze locators.

In contrast, when a terminal to which the method of configuring an index according to the embodiment of the present invention has been applied receives information to be used to configure an EPG, it can analyze a container to be received by performing eight container locator searches using only a single index.

The method and system for providing service search according to the present invention have the advantages of searching for fragments corresponding to a plurality of TVA fragment types at one time and being able to perform search on the basis of a container, including a set of fragments that meet a condition, without enumerating fragment locators.

Furthermore, the method and system for providing service search according to the present invention have the advantages of a terminal reducing memory necessary to store indexes and significantly reducing the procedure of searching for information necessary to configure a service guide.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for providing service search, comprising:
an index formation unit for forming an index structure including an index list area, an index area, and a sub-index area;
a container configuration unit for configuring an integrated container by integrating service information, schedules, and program information for each of service identifiers (IDs) included in the sub-index area;
a guide configuration unit for configuring an Electronic Program Guide (EPG) including the index structure; and
a transmission and reception unit for providing the EPG using a service ID corresponding to information desired by a terminal, together with the index structure.

2. The system as set forth in claim 1, wherein the index list area includes a fragment type, a field and an index pointer, the index area includes a service search range, and the sub-index area includes the service IDs and corresponding container locators corresponding to a location information list of information included in the service search range of the field.

3. The system as set forth in claim 2, wherein the fragment type includes program information, a program location, and service information.

4. The system as set forth in claim 3, wherein the program information, the program location, and the service information are sequentially described in XML Path Language (Xpath).

5. The system as set forth in claim 1, wherein the field includes a service ID and a start time of a schedule corresponding to the service information.

6. The system as set forth in claim 1, wherein the EPG comprises schedules and program information for a specific period of time.

7. The system as set forth in claim 1, wherein the container configuration unit integrates the service information, the schedules and the program information into an XML document type.

8. A method for providing service search, comprising:
forming an index structure including an index list area, an index area, and a sub-index area;
configuring an integrated container by integrating service information, schedules, and program information for each of service IDs included in the sub-index area;
configuring an Electronic Program Guide (EPG) including the index structure; and
providing the EPG using a service ID corresponding to information desired by a terminal.

9. The method as set forth in claim 8, wherein the forming the index structure list area comprises forming the index list region, including a fragment type, a field, and an index pointer.

10. The method as set forth in claim 9, wherein the fragment type includes program information, a program location, and service information.

11. The method as set forth in claim 10, wherein the forming an index structure comprises forming the index area, including a service search range of the field in the index list area.

12. The method as set forth in claim 11, wherein the forming the index structure comprises forming the sub-index area, including the service IDs and container locators corresponding to a location information list of information included in the service search range of the field.

13. The method as set forth in claim 9, wherein the forming the index list area comprises sequentially describing the fragment type in XML Path Language (Xpath).

14. The method as set forth in claim 8, wherein the EPG comprises schedules and program information for a specific period of time.
